(19) United States
(12) Patent Application Publication
(10) Pub. No.: US 2019/0253002 A1
(43) Pub. Date: Aug. 15, 2019

(54) GENERATOR FOR TRANSFORMING A TRANSLATIONAL MOVEMENT OF A BODY INTO AN ACCUMULATION OF ELECTRIC CHARGES

(71) Applicant: Enerbee, Grenoble (FR)

(72) Inventors: Jérôme Delamare, Quaix en Chartreuse (FR); Thibault Ricart, Seyssinet Pariset (FR); Jeremy Laville, Grenoble (FR); Stéphane Vimpierre, Grenoble (FR)

(21) Appl. No.: 16/336,891

(22) PCT Filed: Sep. 20, 2017
(86) PCT No.: PCT/FR2017/052524

§ 371 Date: Mar. 26, 2019

(30) Foreign Application Priority Data
Sep. 27, 2016 (FR) 1659088

(51) Int. Cl. H02N 2/18; H02N 11/00; H02K 7/116

(52) U.S. Cl. CPC H02N 2/18; H02K 7/116; H02N 11/002

(57) ABSTRACT

A generator for transforming a translational movement of a push element into an accumulation of electric charges comprises a converter capable of transforming a magnetic field variation into a charge accumulation, and a magnetic field source defining a housing in which a magnetic field prevails. The push element is movable from a first position to a second position along a translational direction. According to a first aspect, the generator comprises a transmission device for transmitting the movement of the push element into a rotational movement of the field source or of the converter in order to vary the magnetic field in the reference plane of the converter. According to another aspect, the push element is moved from a first position in which the converter is subject to a first field configuration, to a second position in which the converter is subject to a second field configuration, different from the first.

### CROSS-REFERENCE TO RELATED APPLICATIONS

This application is a national phase entry under 35 U.S.C. § 371 of International Patent Application PCT/FR2017/052524, filed Sep. 20, 2017, designating the United States of America and published as International Patent Publication WO 2018/060568 A1 on Apr. 5, 2018, which claims the benefit under Article 8 of the Patent Cooperation Treaty to French Patent Application Serial No. 1659088, filed Sep. 27, 2016.

### TECHNICAL FIELD

The disclosure relates to a generator capable of transforming the translational movement of a body into an accumulation of electric charges.

### BACKGROUND

Such a generator is known from the document “Magnetostrictive-Piezoelectric composite structure for energy harvesting,” Journal of Micromechanics Microengineering, No. 22, 2012 by T. Lafont et al., which includes:
A converter capable of transforming a magnetic field variation into an accumulation of electric charges. The converter consists of a layer of magnetostrictive material joined on each side to a layer of material with piezoelectric properties.
A magnetic field source, in the form of a permanent magnet.

The translational movement of the magnetic field source in a parallel and overhanging plane of the converter results in the accumulation of charges in the converter. These charges can then be taken for storage and/or to supply energy to a circuit.

U.S. Pat. No. 6,984,902 discloses a device for recovering the vibratory energy of a body that also uses a converter and a field source.

However, for a given level of accumulated charge, known devices are relatively cumbersome or inefficient, making them incompatible with some targeted applications. This is particularly the case when trying to recover the energy from a small push element of a more complex device, when this push element is operated by a user (switch, operating button, etc.). In this type of application, it is important to be able to recover as many charges as possible, even when the movement is of small amplitude (from a few mm to a few cm) and low speed (from 0.01 to less than 1 m/s).

### BRIEF SUMMARY

One of the aims of the disclosure is, therefore, to propose a generator, capable of transforming the translational movement of a push element into an efficient and compact accumulation of charge.

In order to achieve this goal, and according to a first aspect, the object of the disclosure proposes a generator to transform a translational movement of a push element into an accumulation of electric charges comprising:
a converter, including a reference plane, and capable of transforming a magnetic field variation in the reference plane into a charge accumulation;
a magnetic field source defining a housing wherein a magnetic field prevails;
the push element, integral with the source or the converter, being movable in a translational direction perpendicular to the reference plane from a first position in which the converter is placed in the housing at a first plane and subject to a first field configuration in its reference plane, to a second position in which the converter is subject to a second field configuration in its reference plane, different from the first.

By placing the converter in the field source housing, a compact generator is formed. The movement of the push element results in the variation of the magnetic field that the converter of a first configuration is subject to, resulting in the generation of electric charges.

According to other advantageous and unrestrictive characteristics of the disclosure, considered individually or in any technically possible combination;
the converter is formed of a layer of a magnetostrictive material defining the reference plane, assembled with at least one layer of a piezoelectric material;
the generator includes means for returning the push element to the first or second position;
in the second position, the converter is placed outside the housing and the second field configuration corresponds to a peripheral field at the magnetic field source:
the magnetic field source comprises an assembly of magnets forming a Halbach cylinder and the first field configuration is a uniform field in the housing:
in the second position, the peripheral field is perpendicular to the reference plane and comes from a source of a peripheral magnetic field;
in the second position of the push element, the converter is placed in the housing in a second plane;
the field source comprises a stack formed by a first Halbach cylinder generating the first field configuration in the first plane, and a second Halbach cylinder generating the second field configuration in the second plane:
the field source comprises a first magnetically permeable element and a second magnetically permeable element configured to orientate the converter according to the first field configuration when the push element is in the first position and according to the second configuration when the push element is in the second position;
the first field configuration and the second field configuration correspond to uniform fields, forming a 90° angle with each other.

According to a second aspect, the object of the disclosure proposes a generator to transform a translational movement of a push element movable from a first position to a second position, according to a translational direction, into an accumulation of electric charges, the generator comprising:
a magnetic field source defining a housing wherein a magnetic field prevails;
a converter, comprising a reference plane, and capable of transforming a magnetic field variation in this reference plane into a charge accumulation, the converter being arranged in the housing in such a way as to place at least a part of the field in the reference plane; and
a device for transmitting the movement of the push element in a rotational movement along an axis perpendicular to the reference plane of the field source or the converter, to vary the magnetic field in the reference plane of the converter.

By placing the converter in the field source housing, a compact generator is formed. The movement of the push element is transmitted into a rotational movement varying the magnetic field with respect to the converter, which results in the generation of electric charges in the converter.

According to other advantageous and unrestrictive characteristics of the disclosure, considered individually or in any technically possible combination:
the converter is formed of a layer of a magnetostrictive material defining the reference plane, assembled with at least one layer of a piezoelectric material:
the transmission device includes a speed-increasing gear;
the transmission device is configured so that the movement of the push element from the first position to the second position results in the magnetic field to rotate in the reference plane by an angle greater than or equal to 90°;
the generator includes means for returning the push element to the first position;
the magnetic field source is an assembly of magnets forming a Halbach cylinder generating a uniform field in the housing;
the direction of travel is parallel to the reference plane;
the transmission device includes a rack and pinion integral with the push element cooperating with a gear wheel integral with the source or the converter:
the direction of the translation is perpendicular to the reference plane;
the transmission device includes a threaded rod integral with the push element cooperating with a nut that is only free to rotate;
the transmission device consists of a transmission belt and at least two rollers.

### BRIEF DESCRIPTION OF THE DRAWINGS

The disclosure will be better understood in the light of the following description of the specific and unrestricted embodiments of the disclosure with reference to the attached figures, including:

FIGS. 1A and 1B schematically represent two overviews of generators compatible with the disclosure;

FIGS. 1C and 1D respectively represent a cross-section and a top view of an electromagnetic converter compatible with an electrical generator according to the disclosure;

FIG. 2 is a graphic representation of the amount of charges generated by the converter as a function of the angle e between the magnetic field direction and the polarization direction of the piezoelectric layers;

FIGS. 3A to 3C represent different possible configurations of a magnetic field source of the electric generator according to the disclosure;

FIGS. 4A to 4C represent different views of a first example of the implementation of the disclosure according to a first embodiment;

FIG. 5 shows a gear train;

FIG. 6 schematically represents a second example of the implementation of the disclosure according to its first embodiment;

FIG. 7 schematically represents a third example of the implementation of the disclosure according to its first embodiment;

FIG. 8 schematically represents a fourth example of the implementation of the disclosure according to its first embodiment;

FIGS. 9A and 9B schematically represent a first example of the implementation of the disclosure according to a second embodiment;

FIGS. 10A and 10B represent an alternative to the first example in FIGS. 9A and 9B;

FIGS. 11A and 11B schematically represent a second example of the implementation of the disclosure according to its second embodiment;

FIGS. 12A, 12B, and 12C schematically represent a third example of the implementation of the disclosure according to its second embodiment.

### DETAILED DESCRIPTION

This disclosure relates to an electrical generator 1 capable of transforming the translational movement of a body, even of small amplitude (from a few mm to a few cm) and low speed (from 0.01 to less than 1 m/s), into a generation and accumulation of electric charges.

### Elements Common to All Embodiments

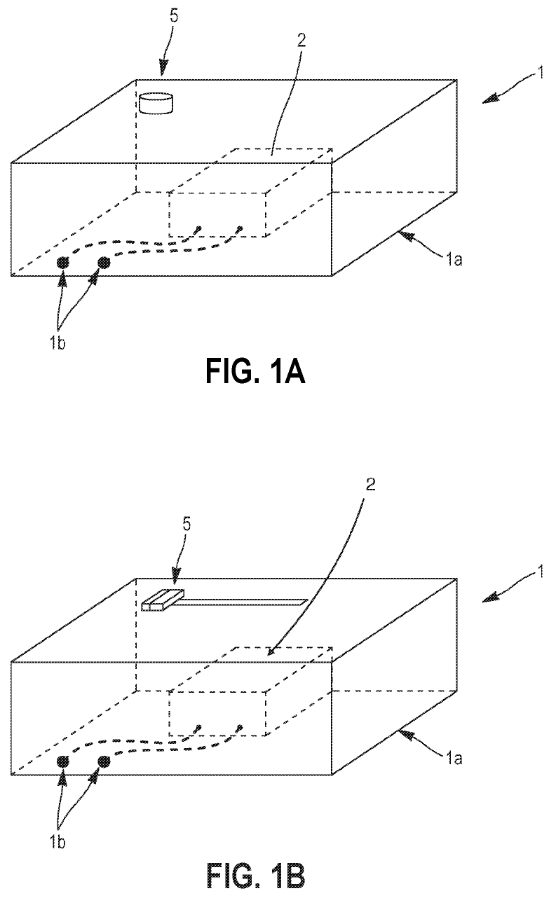

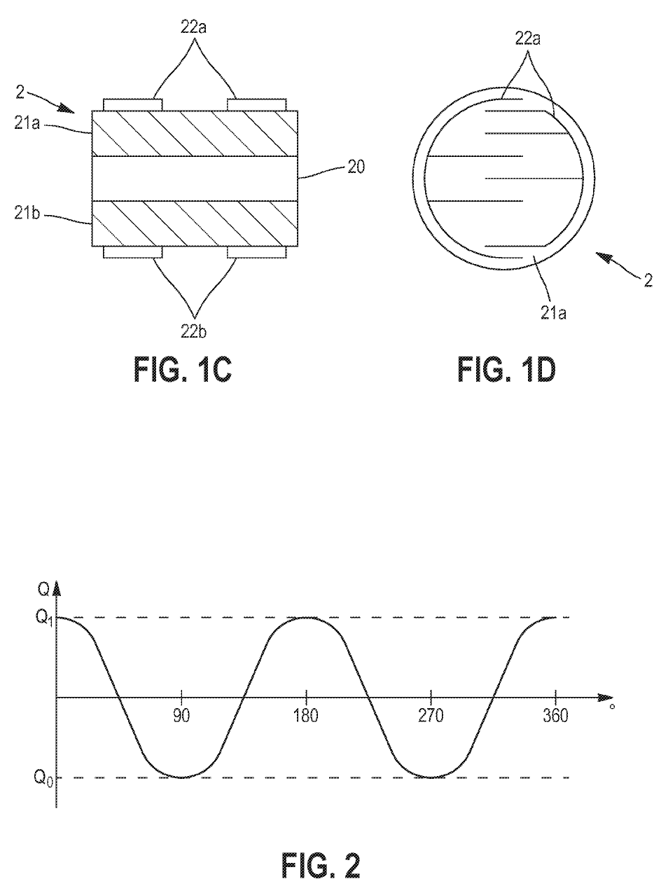

FIGS. 1A and 1B schematically represent two exemplary embodiments of such a generator 1. In an optional case 1a, the generator includes a push element 5 connected with a converter 2. The converter is electrically connected to two terminals 1b that can be integrated into the case 1a, for the electrical connection thereof with an associated device.

The push element 5 can be moved along a translational direction from a first position to a second position. This can be, for example, a push button that can be directly or indirectly activated in translation by a user. This translational movement can take different forms, for example, in a direction perpendicular to a main surface of the case 1a as shown in FIG. 1A, or in a direction in the plane of the case 1a as shown in FIG. 1B.

The push element 5 can be included in a part of a more complex mechanical device, such as a switch, resulting in the translational movement of the push element 5, when this complex mechanical device is operated by the user.

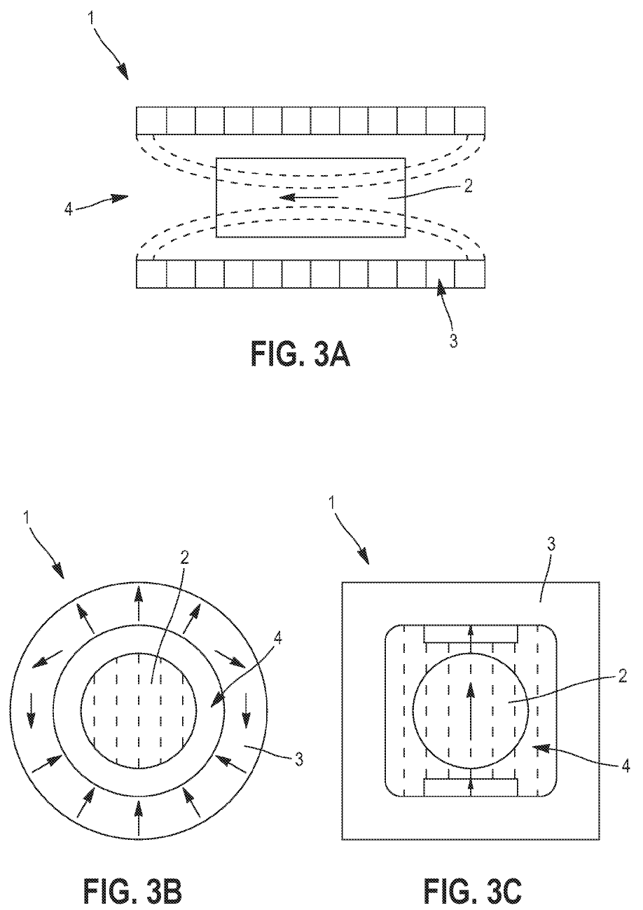

As shown as an example in FIGS. 3A to 3C, the generator 1 according to the disclosure also includes a magneto-electric converter 2 and a magnetic field source 3, such as a permanent magnet. The converter 2 and the source 3 can move relative to each other. The source 3 defines a housing 4 wherein the converter 2 can be placed and form a particularly compact unit. The energy resulting from the translational movement of the push element 5 will be partially recovered by the assembly formed by the converter 2 and the magnetic field source 3, and transformed into electric charges. These charges are collected, and possibly stored using a control device associated with the generator 1 (which can be connected to the terminals 1b). They can be used, for example, to power and enable the operation of an electric or electronic device such as a signal transmitter connected to the generator 1. As complementary examples, they can also be used to recharge a battery, or to power a sensor or a network of environmental data sensors (temperature, humidity, etc.). Such a control device is known, for will not be described here in greater details.

FIGS. 1C and 1D represent a particular example of a magneto-electric converter 2 compatible with an electrical generator 1 according to the disclosure. The converter 2 is capable of transforming the magnetic field variation in a reference plane into a charge accumulation.

The converter 2 includes a magnetostrictive layer 20 of magnetostrictive material with a preferred magnetostriction coefficient, in absolute value and in saturation, above 10 ppm, above 100 ppm, or even above 1,000 ppm. It should be recalled that this coefficient is defined by the quotient AL/L where AL is the elongation of the material in the presence of a magnetic field saturating the material, and L is the length of this material in the absence of a magnetic field.

Preferably, the material of the magnetostrictive layer 20 is chosen to be inherently isotropic or to exhibit isotropic behavior in the generator 1, as is the case when an anisotropic material is subject to a field of sufficient intensity to saturate it magnetically. It can be made of a Terfenol D, FeSiB, or a FeCo alloy block, for example.

As can be seen in FIG. 1D, on the top view of the converter 2, the magnetostrictive layer 20 can have a disc shape. The magnetostrictive layer 20 defines a reference plane for the converter 2 and the generator 1 wherein it is placed. This disc shape enables the converter to rotate on itself, or to be inserted into a rotating element, with an axis perpendicular to the reference plane and passing close to the center of the disc, in a limited generated volume.

As is well known per se, the application of a magnetic field to the magnetostrictive layer 20 in a given direction in the reference plane causes the layer to deform along this determined direction (an elongation when the magnetostriction coefficient of the magnetostrictive layer 20 is greater than 0).

The magneto-electric converter 2 also comprises, assembled integrally with the magnetostrictive layer 20, at least one piezoelectric layer 21a, having electrodes 22a. In the example shown in FIG. 1C, two piezoelectric layers 21a, 21b are assembled respectively on both sides of the magnetostrictive layer 20. Each of these piezoelectric layers 21a, 21b has electrodes 22a, 22b at least on one side, for example, on the exposed side thereof. As shown in FIG. 1D for the electrode 22a, the electrodes 22a, 22b can be interdigital to effectively collect the charges of each of the piezoelectric layers 21a, 21b.

As the piezoelectric layers 21a, 21b are integrally joined to the magnetostrictive layer 20, the deformation of this magnetostrictive layer 20 in the reference plane also results in the deformation of the piezoelectric layers 21a, 21b in a plane parallel to this reference plane.

The piezoelectric layers 21a, 21b are preferably polarized along a polarization direction contained in the plane they define. When several piezoelectric layers 21a, 21b are present, they are advantageously arranged on the magnetostrictive layer 20 so that their polarization axes are arranged parallel to each other. It will be considered that this is the case in the coming description.

The deformation of the piezoelectric layers 21a, 21b along their polarization directions results in the creation of electric charges in these layers and the accumulation thereof on the electrodes 22a, 22b. Such deformation is obtained when the magnetostrictive layer 20 is subject to a magnetic field the orientation of which has a component parallel to the polarization direction of the piezoelectric layers 21a, 21b.

FIG. 2 is a graphic representation of the amount of charges generated on the electrodes 22a, 22b as a function of the angle θ between the direction of a uniform magnetic field developing in the magnetostrictive layer 20 and the polarization direction of the piezoelectric layers 21a, 21b. It can be seen that, in the absence of the collection thereof, the accumulated charges oscillate between a maximum value Q1 and a minimum value Q0. The maximum value is reached when the angle θ is equal to 0° and 180°, i.e., when the directions of the magnetic field and the polarization axis are parallel. The minimum value QO is reached when the angle θ equals 90° and 270°, i.e., when the directions of the magnetic field and the polarization axis are perpendicular. Between two consecutive extremes, (positive or negative) charges are, therefore, created in the piezoelectric layers 21a, 21b.

Advantageously, when the converter 2 is subject to a rotating magnetic field, the control circuit is configured to collect the charges created upon each quarter turn, for angles θ of 0°, 90°, 180° and 270°, within 30°.

A magneto-electric converter 2 is thus formed that is able to transform the variations, in the reference plane defined by the magnetostrictive layer 20, of a magnetic field into a charge accumulation at the electrodes 22a, 22b of the piezoelectric layers 21a, 21b.

It should be noted that the generator according to the disclosure is by no means limited to a converter 2 of the precise form just described. Thus, a converter 2 comprising a single piezoelectric layer 21a or comprising a plurality of magnetostrictive layers is fully compatible with the disclosure. Similarly, the electrodes 22a, 22b may take other forms or be deployed differently from what has been described in the previous paragraphs.

A generator 1 also includes a magnetic field source 3. The magnetic field source 3 defines a housing wherein a magnetic field prevails. In FIGS. 3A to 3C, this field is represented by the dotted field lines.

The housing 4 and the source 3 are configured so that the converter 2 can be placed in the housing in such a way that at least one part of the field is placed in its reference plane. The source 3 and the converter 2 are free to move relative to each other, so that a rotating field can be created in the housing 4 opposite the converter.

Preferably, the field prevailing in the housing 4 is uniform, i.e., it has a relatively constant direction and/or intensity at least in a central part of the housing and preferably at any point of the housing. This makes it easy to place the converter in the housing 4 without having to accurately position it in a particular location.

There are multiple ways to realize the field source 3.

According to a first approach, the source 3 is formed by a flat assembly of permanent magnets oriented relative to each other so as to confine a magnetic field on one side of this plane. This assembly is well known as the “Halbach network.”

By placing two of these assemblies facing each other, with the fields facing each other, the housing 4 is defined as the space between these two planes. This configuration is shown in FIG. 3A. It should be noted, however, that it is not necessary to have two flat assemblies, and that a single assembly is sufficient to generate a useful magnetic field.

In a second approach, a plurality of permanent magnets are arranged relative to each other along a closed contour to define the housing 4 and create a field within it. For example, it may be a Halbach cylinder configuration, shown schematically in FIG. 3B.

As a complementary example, it can be a closed structure made of soft iron, defining the housing, two permanent magnets of identical magnetic moment are placed opposite each other in the housing as shown in FIG. 3C.

Regardless of the chosen source 3 configuration, the converter 2 is placed in the housing 4 so that at least part of the prevailing field is placed in the reference plane.

Apart from the housing 4, there is a peripheral field that can correspond, for example, to the terrestrial magnetic field. The configuration of the peripheral field (i.e., the intensity, direction thereof) is different from the configuration of the field prevailing in the housing 4.

This disclosure takes advantage of the various elements that have just been described in detail to form a device capable of transforming the translational movement of a body into an accumulation of electric charges.

### First Embodiment

In this embodiment, the magnetic field generated by the source 3 in the housing 4 can be rotated with respect to the converter 2 along an axis perpendicular to the reference plane. This forms a rotating and, therefore, variable field in the reference plane resulting in the generation of charges on the electrodes 22a, 22b of the converter 2.

The rotation of the field can be obtained by rotating the converter 2 about itself about an axis of rotation perpendicular to the reference plane and able to pass through its center.

Alternatively, the rotating field can be obtained by holding the converter stationary and rotating the field source 3 about the axis of rotation perpendicular to the reference plane and passing through or near the center of the converter 2. This configuration, wherein the converter 2 is stationary, is particularly advantageous, as it enables the control device to be simply connected to the converter 2.

Of course, the converter 2 and the source 3 can simultaneously be rotated, as long as they are in relative movement with respect to each other, in order to rotate the field with respect to the converter 2.

Regardless of the approach chosen, the converter 2 is held in the housing and subject to the variable (e.g., rotating) magnetic field in its reference plane.

In this first embodiment of the disclosure, the generator 1 also includes a device for transmitting the translational movement of the push element 5 into a rotational movement of the source 3 or the converter 2, with an axis perpendicular to the reference plane. In other words, the translational movement of the push element 5 from a first position to a second position results in the rotational movement of the source 3 or the converter 2, preferably on itself, and along an axis perpendicular to the reference plane. As we have seen, this rotational movement results in the formation, in the housing 4 of the source 3, of a rotating magnetic field with respect to the converter 2, and in the generation and accumulation of electric charges on the electrodes 22a, 22b of the converter 2.

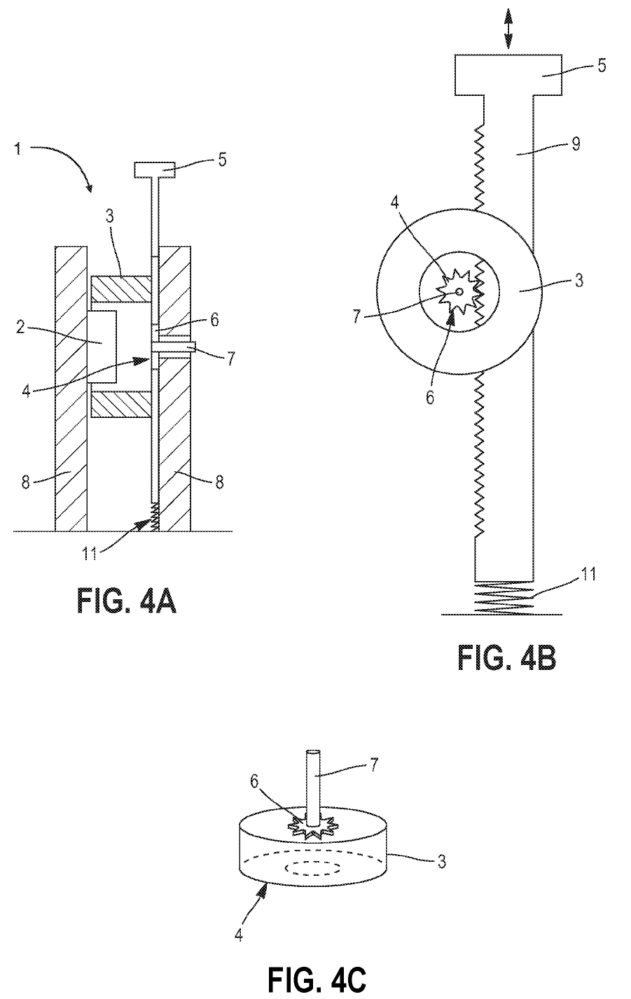

FIGS. 4A to 4C represent different views of a simple example of the implementation of the disclosure according to this embodiment.

In this example, the field source 3 is a Halbach cylinder generating a uniform field in at least one part of the housing 4 it defines. The core of this cylinder defines the housing 4 wherein the converter 2 can be placed. As can be seen in FIG. 4C, a circular face of the cylinder has an opening giving access to the housing 4 to place the converter 2 therein (not shown in this figure). On the other flat circular face of the cylinder, a gear wheel 6 and an axle 7 are coaxially attached. As can be seen on the side section of FIG. 4A, the free end of the axle 7 is supported by a wall 8 of the case 1a, allowing the cylindrical magnetic field source 3 to be held in position while maintaining its rotational movement around the axle 7. The converter 2 is positioned in the housing, and held stationary on a second wall 8 of the case 1a. The rotation of the cylindrical magnetic field source 3 creates a rotating field in the reference plane of the converter. The gear wheel 6 attached to the source 3 cooperates with a rack 9 integral with the push element 5. The translational movement of the push element 5 along the main direction of the rack, causes the translational movement of the rack too and the rotation of the source 3.

The configuration of the rack 9 and the gear wheel 6 should be chosen so that the movement, even of small amplitude, of the push element 5 results in the rotation of the magnetic field by an angle sufficient to accumulate a required quantity of electric charges. The source 3 can be moved in rotation by several turns when the push element 5 moves in translation from its first to its second position, or by a portion of a turn, depending on the energy required for the application.

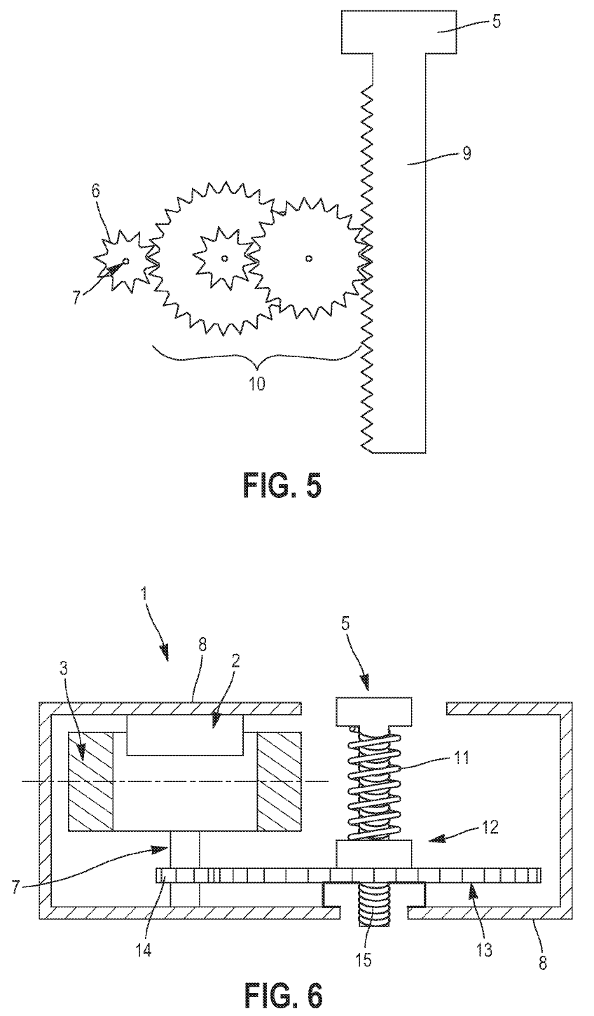

To facilitate this, a gear reduction mechanism or a gear train 10 can be provided between the rack 9 and the gear wheel 6, a particular example of which is shown in FIG. 5. This mechanism can be attached to a wall 8 of the generator 1.

Advantageously, the generator 1 can be provided with a return element 11, such as a spring, to reposition the push element 5 in its first position after it has reached the second position. The return movement of the push element 5 from the second position to the first position can be used to continue generating and accumulating charges. For this accumulation to be useful, it must be ensured that the control device is capable of collecting charges in this dual mode of operation.

To ensure a maximum charge generation, especially when the rotational movement of the magnetic field is less than one revolution when the push element is activated, it is particularly advantageous to orient the converter 2 toward the field so that, in the first position, the polarization axis of the piezoelectric layer is aligned with the magnetic field prevailing in the housing 4 (or perpendicular thereto). Thus, when the push element 5 is positioned in its first position, the deformation of the converter along the direction of the polarization axis is extreme (maximum or minimum).

Many variations of this example of the first embodiment of the disclosure are possible.

Thus, the gear wheel 6 is not necessarily placed against a circular face of the cylinder 3 as shown in FIGS. 4A to 4C. Alternatively, the gear wheel 6 can be formed by providing the outer contour of the magnetic field source 3 with teeth that can cooperate with the rack 9 or with the teeth of a gear train 10.

In the example shown in FIGS. 4A to 4C, the translational movement of the push element 5 is performed in a plane parallel to the reference plane. By providing some of the gears 9, 6, 10 with bevel gears, it is possible to orient the movement of the push element 5 to any angular position with respect to the reference plane. In particular, it may be placed in a plane perpendicular to the reference plane.

According to another alternative solution to this first embodiment, the push element 5 and/or the rack 9 can be equipped with a limit switch locking device, which has the effect of holding the push element 5 in this position once it has reached this extreme position. The locking device can be released by applying an additional force to the push element, and this element put into translation by taking advantage of the returning forces exerted by the return element 11. As mentioned above, this return movement can also make it possible to generate and accumulate electric charges.

FIG. 6 schematically shows a second example of the implementation of the disclosure according to its first embodiment. The source 3 and the converter 2 have a configuration similar to the previous example. However, in this example, the transmission device includes a threaded rod or a screw 15, integral with the push element 5.

The screw 15 in the example shown is positioned in a direction perpendicular to the reference plane. The screw cooperates with a nut 12, itself attached to a gear wheel 13 so that the translation of the screw along its longitudinal axis drives the nut 12 and the gear wheel 13 in rotation. The nut 12 is free to rotate about the main axis of the screw 15 only. The thread of the screw 15 and the grooving of the nut 12 are chosen to enable the reversible transmission of the rotational and translational movements of each of these parts. The gear wheel 13 engages a pinion 14 attached to an axle 7, driving the field source 3 in rotation. A return element 11, such as a spring, is used to return the push element 5 to its starting position.

Similar to the previous example, a more complex gear train, such as the one shown in FIG. 5, can be incorporated to ensure that a translational movement, even of small amplitude, can cause the source 3 to rotate sufficiently angularly by at least 90°, within 30°.

The integration of pinion and bevel gear type elements into the gearing can also enable the movement of the push element 5 so that it is placed in a different angular position than the one shown and described. And in this example, a limit switch locking device can also be provided as described in relation to the first example.

In some configurations, the pinion 14 can be omitted by providing the outer contour of the magnetic field source 3 with teeth cooperating with the gear wheel 13.

The walls 8 of the case make it possible to keep the elements of the generator 1 inside a compact volume.

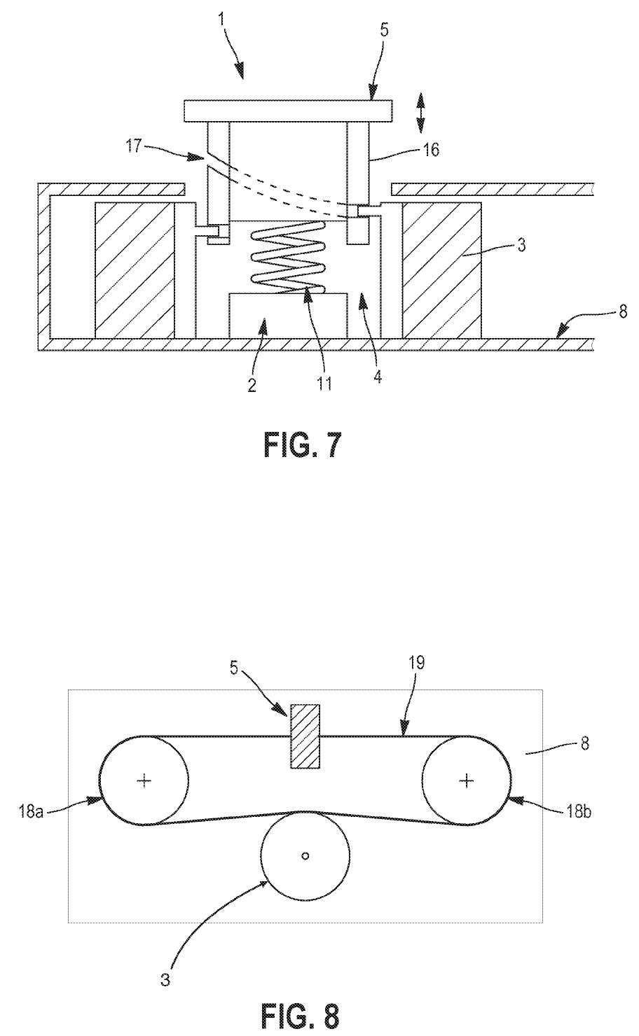

FIG. 7 schematically shows a third example of the implementation of the disclosure according to its first embodiment.

As in the preceding two examples, a circular converter 2 is placed on a wall 8 of a case 1a, inside the housing 4 of a magnetic field source 3 consisting of a Halbach cylinder. The field source 3 is not attached to the support wall 8, so it is free to rotate. This movement can be facilitated by providing the support walls 8, with which it is in contact, with ball bearings, rollers, lubricants, etc.

The transmission device consists of a cylindrical body 16, with a first pattern 17 such as a groove or a helical rib. The push element 5 is attached to a circular face of the cylindrical body 16. The inside of the cylinder 3 is provided with a second pattern, a rib or a groove, complementary and cooperating with the first pattern 17 of the cylindrical body 16. A pressure on the push element 5 causes it to move in translation along an axis perpendicular to the reference plane, and causes the source 3 to rotate. The choice of the pitch of the pattern 17 makes it possible to determine the angular movement of the source 3 for the amplitude of the permitted translation of the push element 5. It is also chosen to enable the reversible transmission of the rotational and translational movements of each of these parts.

Return element 11 is in contact with the wall of the support (or with the converter 2 as shown in FIG. 7 and with a surface of the cylindrical body 16 so as to return the push element 5 (and the cylindrical body 16) to its initial position. As in the previous examples, it is also possible to provide a limit switch locking device as explained in relation to the first example of this method of implementation of the disclosure.

As in the previous examples, the translational movement of the push element 5 results in the formation of a rotating magnetic field in the reference plane of the converter 2 and in the accumulation of charges that can be collected by the control device associated with the generator 1.

FIG. 8 schematically shows a top view of a fourth example of the implementation of the disclosure according to its first embodiment.

The push element 5 is fixedly attached to a transmission belt 19. The movement of the transmission belt 19 and the push element 5 is guided by at least two rollers 18a, 18b attached on a wall 8 but free to rotate on themselves. Advantageously, the transmission of the movement between the transmission belt 19 and the rollers 18a, 18b is carried out without slipping. For this purpose, a synchronous belt with teeth of a chosen shape can be used to mesh with the teeth that can be fitted to the rollers 18a, 18b. Alternatively, a transmission belt 19 can be chosen in the form of a chain.

The transmission belt 19 and the two rollers 18a, 18b form the transmission device for the translational movement of the push element 5 into a rotational movement of the magnetic field source 3 to vary this magnetic field in the reference plane of the converter.

For this purpose, a circular converter 2 is placed on the wall 8, inside the housing 4 of a magnetic field source 3 consisting of a Halbach cylinder, which can be driven into rotation by the transmission belt 19.

The translational movement of the push element 5 causes the movement of the transmission belt 19 and the rotation of the magnetic field source 3. This rotation results in the formation of a rotating magnetic field in the reference plane of the converter 2 and in the accumulation of charges that can be collected by the control device associated with the generator. The same principle could be used to move the converter 2 in rotation rather than the field source 3, in order to produce a variable field in the reference plane of the converter 2.

### Second Embodiment

In this second embodiment, the push element 5 is integral with the field source 3 or the converter 2. The push element 5 can be moved in a direction perpendicular to the reference plane, and thus moves the source 3 or the converter 2 to which it is attached.

In a first position of the push element 5, the converter 2 is placed in the housing 4 of the source 3 in a foreground position and subject to a first field configuration.

“Field configuration” means the intensity and orientation of the magnetic field (in particular, with respect to the polarization direction of the converter 2) at any point in the space of the housing 4 occupied by the converter 2, at its reference plane.

The push element 5 moved to a second position moves the source 3 or the converter 2 to which it is attached. When the push element 5 is in the second position, the converter 2 is subject to a second field configuration in its reference plane. This second field configuration is different from the first.

The field variation between the first position and the second position of the push element 5 at the reference plane results in the generation of charges in the piezoelectric layer(s) 21a, 21b of the converter 2, and the accumulation thereof on the electrodes.

A return element 11, such as a spring, enables the push element 5 to be repositioned in its first or second position.

FIGS. 9A and 9B schematically represent a first example of the implementation of the disclosure in this second embodiment.

In FIG. 9A, the push element 5, integral with the converter 2, is in its first position. The converter 2 is placed in the housing 4 of a field source 3, the composition of which may be chosen in accordance with what has been set out in the part common to all the embodiments of the disclosure. This source 3 is attached to the support walls 8.

FIG. 9B shows the generator 1 when the push element 5 is in its second position, after it has been moved in translation.

In this first example, the converter 2 was driven out of the housing 4 defined by the source 3. It is then no longer subject to the field prevailing in this housing 4 but to a peripheral field that is different from the housing field, of much lower intensity, and of any orientation. This field variation induces the generation of charges on the piezoelectric layers 21a, 21b of the converter 2 and the accumulation thereof on the electrodes 22a, 22b (see FIGS. 1C and 1D). A control device (not shown) can be configured to contact these electrodes when the converter 2 is moved to the end of the stroke, for example, to the second position of the push element 5, as shown in FIG. 9B. Alternatively, the electric connection between the converter 2 and the control device terminals can be provided by means of conductive springs or by simple wire connections.

To maximize the variations in the field perceived in the reference plane by the converter 2 between the first and the second position, and to be protected from possible permanent or residual magnetization effects of the magnetostrictive layer 20 (FIG. 1C), the generator 1 can be provided with a peripheral field source 23. This source 23 can generate a field, the direction of which is perpendicular to the reference plane, and can be placed near the converter 2 when it is positioned outside the housing 4, i.e., when the push element 5 is in the second position. The peripheral field is thus used to restore an initial level of low magnetization/deformation of the magnetostrictive layer in the reference plane. The maximization of the potential for generating charges is thus ensured.

In this example, the field source is stationary, which allows greater freedom in its sizing. In this case, a larger source 3 can be chosen in order to generate a high intensity field in the housing 4 and to maximize the potential for generating charges.

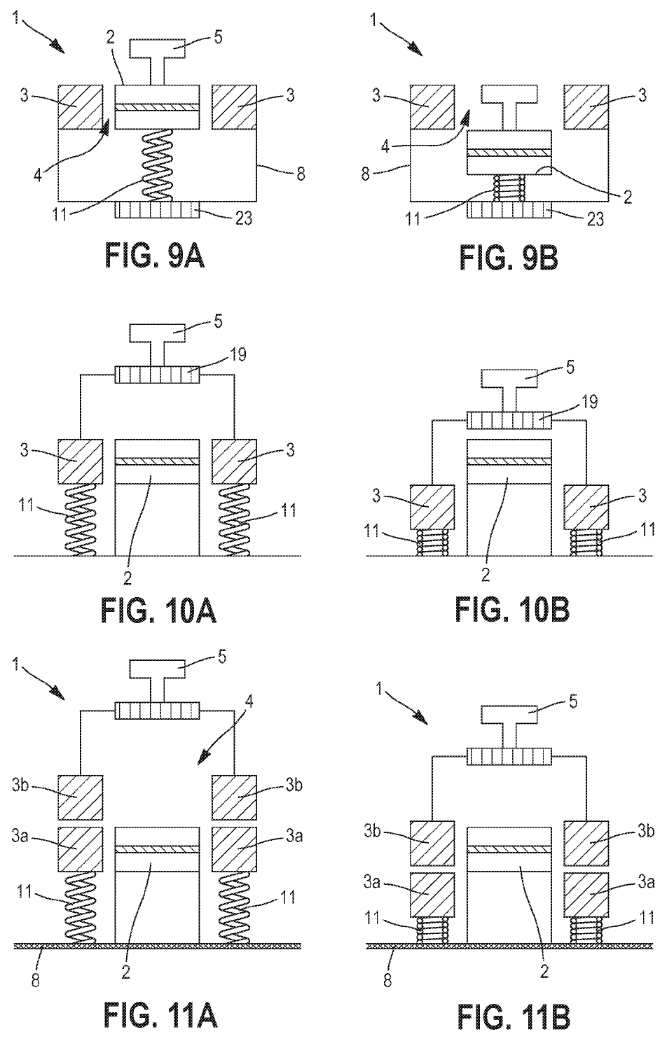

FIGS. 10A and 10B represent an alternative to this first example. In this alternative, the push element 5 is attached to the field source 3. It is, therefore, the source 3 that is moved this time when the push element 5 moves from its first position to the second position.

As the converter 2 is stationary, its interface with the control device is simplified.

The operation of this alternative is similar in every respect to the operation of the first example that has just been made.

FIGS. 11A and 11B schematically represent a second example of the implementation of the disclosure in the second embodiment.

In this example, the field source 3 is composed of two distinct parts 3a, 3b, each of which is capable of generating a distinct field configuration. For example, the part 3a of the source 3 is capable of creating a first field configuration oriented in a plane parallel to the reference plane and along a first direction. The part 3b of the source 3 is capable of creating a second field configuration oriented in a plane parallel to the reference plane and along a second direction, different from the first. Advantageously, this second direction forms a 90° angle with the first one. The field strength generated by the first part 3a and the second part 3b are not necessarily the same. The source 3 can be simply an assembly or a stack of permanent magnets, the moments of which are chosen to direct the fields in the determined direction. This may be, for example, a stack of two identical Halbach cylinders, offset in the stack by an angular position of 90° , within 30°.

FIG. 11A shows the generator 1 when the push element 5 is in the first position. The converter 2 is placed in the housing 4 of the source 3 according to a first plane subjecting the magnetostrictive layer 20 to a first field configuration generated by the part 3a of the source 3.

FIG. 11B shows the generator 1 when the push element 5 is in its second position. It can be seen in this figure that the converter 2 is then placed in the housing 4 of the source 3 opposite the part 3b of the source. The converter 2 is then subject, in its reference plane, to the second field configuration. As in the previous example, the field variation in the reference plane of the converter 2 when moving the push element 5 between the two positions results in the generation of charges in the converter 2 and in the accumulation thereof on the electrodes.

In this particular example, the converter is attached to a wall 8 of the case 1a, so it can be easily connected to the control circuit enabling, among other things, collection of the charges.

While remaining within the framework of this example, it can be considered to have a source 3 having more than two parts 3a, 3b, each of the parts enabling generation of a field configuration distinct from the field configurations generated by the parts directly adjacent thereto. By carefully choosing the configuration of each of the fields, for example, by shifting the fields of two adjacent parts by 90° (within 30°), it is possible to simulate the application of a rotating field in the reference plane of the converter 2, when moving it in the source 3 housing. This increases the amount of collectible charges.

As in the previous example, an alternative solution can be provided, wherein the push element 5 would be attached to the converter 2, and not to the field source 3.

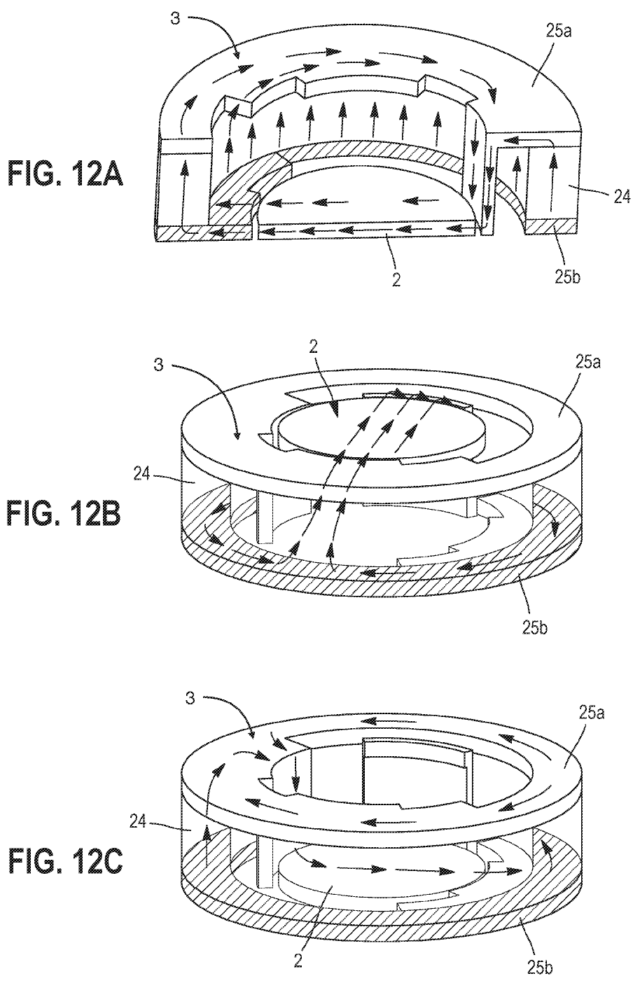

FIGS. 12A to 12C schematically represent a third example of the implementation of the disclosure according to the second embodiment thereof. In this example, the magnetic field source 3 is configured to generate two distinct field configurations depending on the position of the converter 2.

As can be seen on the cross-section shown in FIG. 12A, the magnetic field source 3 comprises a hollow (and cylindrical in the example shown) magnet 24 and a first and a second permeable magnetic elements 25a, 25b arranged on either side of the magnet. The magnetic field from the magnet 24 closes on the converter 2 as it flows through the permeable magnetic elements 25a, 25b. The field flow is represented by the arrows in FIG. 12A.

The converter 2 placed in the housing 4 is driven in translation from a first plane parallel to the reference plane to a second plane when the push element 5 (not shown in these figures) is moved from its first to its second translational position. These two positions are shown in FIGS. 12B and 12C, respectively.

The first element and the second magnetic permeable elements 25a, 25b are configured to close and direct the magnetic field onto the converter 2 in a first field configuration when the converter is in the foreground (FIG. 12B).

The first and the second magnetic elements 25a, 25b are configured to close and direct the magnetic field from the source 3 to the converter 2 in a second field configuration when the converter is in the second plane (FIG. 12C).

As in the previous examples, the field variation in the reference plane of the converter 2 between the two positions results in the generation of charges in the converter 2 and the accumulation thereof on the electrodes.

It should be noted that this exemplary implementation does not exclude that the source 3 and the converter 2, whether placed in the first or the second plane, can be moved in rotation with respect to each other to generate a variable (e.g., rotating) magnetic field with respect to the converter 2. Charges can thus be generated in the converter 2 and accumulated on the electrodes for both rotational and translational movements of the push element 5.

Of course, the disclosure is not limited to the methods of implementation described and alternative embodiments can be made without going beyond the scope of the disclosure as defined by the claims.

1. A generator for transforming a translational movement of a push element into an accumulation of electric charges, comprising:
a converter having a reference plane, the converter capable of transforming a magnetic field variation in the reference plane into a charge accumulation;
a magnetic field source defining a housing in which a magnetic field is present; and
the push element, the push element being connected with the magnetic field source-or the converter, the push element being movable along a translational direction perpendicular to the reference plane from a first position in which the converter is positioned in the housing at a first plane and subject to a first magnetic field configuration in the reference plane of the converter, to a second position in which the converter is subject to a second magnetic field configuration in the reference plane of the converter, the first magnetic field configuration being different from the first magnetic field configuration.

2. The generator of claim 1, wherein the converter is formed of a layer of a magnetostrictive material defining the reference plane, joined to at least one layer of a piezoelectric material.

3. The generator of claim 1, further comprising an element for returning the push element to the first positon or the second position.

4. The generator of claim 1, wherein the converter is located outside the housing in the second position, and the second magnetic field configuration corresponds to a peripheral field at the magnetic field source.

5. The generator according to claim 4, wherein the magnetic field source comprises an assembly of magnets forming a Halbach cylinder, and the first magnetic field configuration is a uniform field in the housing.

6. The generator of claim 4, wherein, in the second position, the peripheral field is perpendicular to the reference plane and comes from a peripheral magnetic field source.

7. The generator of claim 1, wherein, in the second position of the push element, the converter is located in the housing a second plane.

8. The generator of claim 7, wherein the magnetic field source comprises a stack formed by a first Halbach cylinder generating the first magnetic field configuration in the first plane, and a second Halbach cylinder generating the second magnetic field configuration in the second plane.

9. The generator of claim 7, wherein the magnetic field source comprises a first magnetically permeable element and a second magnetically permeable element configured to direct the magnetic field on the converter in the first magnetic field configuration when the push element is in the first position and in the second magnetic field configuration when the push element is in the second position.

10. The generator of claim 7, wherein the first magnetic field configuration and the second magnetic field configuration correspond to uniform fields, oriented at a 90° angle relative to one another.

11. A generator for transforming a translational movement of a push element movable from a first position to a second position, along a translational direction, into an accumulation of electric charges, the generator comprising:
a magnetic field source defining a housing in which a magnetic field is present;
a converter having a reference plane, the converter capable of transforming a magnetic field variation in the reference plane into a charge accumulation, the converter being disposed in the housing so as to place at least a part of the magnetic field in the reference plane; and
a transmission device for transmitting the translational movement of the push element into a rotational movement of the magnetic field source or the converter about an axis perpendicular to the reference plane to vary the magnetic field in the reference plane of the converter.

12. The generator of claim 11, wherein the converter comprises a layer of a magnetostrictive material the reference plane, and at least one layer of a piezoelectric material joined to the magnetostrictive material.

13. The generator of claim 11, wherein the transmission device comprises a speed increasing gear.

14. The generator of claim 11, wherein the transmission device is configured so that the movement of the push element from the first position to the second position causes rotation of the magnetic field in the reference plane by an angle greater than or equal to 90°.

15. The generator of claim 11, further comprising man element for returning the push element to the first position.

16. The generator of claim 11, wherein the magnetic field source comprises an assembly of magnets forming a Halbach cylinder generating a uniform field in the housing.

17. The generator of claim 11, wherein the translational direction is parallel to the reference plane.

18. The generator of claim 17, wherein the transmission device comprises a rack integral with the push element cooperating with a gear wheel integral with the source or the converter.

19. The generator of claim 11, wherein the translational direction is perpendicular to the reference plane.

20. The generator of claim 19, wherein the transmission device comprises a threaded rod integral with the push element and cooperating with a nut free in rotation only.

21. The generator of claim 11, wherein the transmission device comprises a transmission belt and at least two rollers.
